(19) United States
(12) Patent Application Publication
(10) Pub. No.: US 2015/0269160 A1
(43) Pub. Date: Sep. 24, 2015

(54) METHOD FOR ORGANISING CONTENT

(71) Applicant: Lifecake Limited, London (GB)

(72) Inventors: Aram Nicholas Babaian, London (GB); Ed Botterill, London (GB); Peter Triplow, Dorset (GB); Matthew Sheppard, London (GB); Marc Holgate, Cambridgeshire (GB)

(21) Appl. No.: 14/434,666

(22) PCT Filed: Oct. 10, 2013
(86) PCT No.: PCT/EP2013/071215

§ 371 Date: Apr. 9, 2015

(30) Foreign Application Priority Data
Oct. 10, 2012 (GB) 1218183.0

(51) Int. Cl. G06F 17/30

(52) U.S. Cl. CPC G06F 17/3053; G06F 17/30864; G06F 17/30312

(57) ABSTRACT

A content manager is described which offers a facility to a user to display, review and rate content items. Content items are assigned prioritization scores, influencing the manner in which those content items are organised. Prioritization scores are themselves determined on the basis of information inherent to a content item, such as the specification of the content item or associated descriptive data, and information provided by a user, such as by gestures or other input techniques, indicative of interest in that content item by that user. These prioritization scores are in turn used to rank content and reduce the memory, bandwidth, processing power and screen real estate used to present content to users.

### FIELD

Embodiments described herein relate to the organisation of digital media content on a computerised storage system.

### BACKGROUND

The generation and storage of digital media content is now highly popular among consumers. This includes, without limitation, the production of photographic and video content. The cost of digital photography and video equipment has fallen, and has become increasingly easy to use. Indeed, digital photography and video recording functionality is now provided as a matter of course in most popular high specification mobile telephones (so called “smartphones”). Each of these factors has contributed to a significant increase in the amount of content that can be, and is, produced by the average user. Whereas, with traditional equipment such as film based cameras, there was a limitation on the number of photographs that a typical user would want to produce and develop into photographic prints (usually governed by the cost of consumables and of the development process), there is no such limitation now placed on users.

Users may still wish to generate photographic prints from digitally produced content, but it is likely that not all generated content will be suitable for printing. Indeed, some generated content might not be valued sufficiently highly by a user to warrant a decision to print but, equally, there may be no desire to discard the digital content. Typically, users will only discard digital content which is of such poor quality, or which is replicated by other content, that there is no desire for it to be retained. Otherwise, users are minded to retain all content that they produce.

This has led to a substantial increase in the amount of content that a user might want to retain, on digital storage means such as a hard disk drive of a computer, a non-volatile memory such as a flash drive, or on an internet based storage facility (now commonly described as “cloud” based storage).

On mobile devices in particular the capacity of content storage can be a constraint. Most content will need to be stored in the cloud to overcome these limitations.

The organisation of content within a storage facility can present problems. Operating systems offer file storage facilities, which can be used to store digital content files. More specialised file storage programs also exist, specifically for the storage of digital media content. The latter tend to mimic the former, in the manner in which they organise content files for presentation to the user. That is, they generally organise content by creation date, thereby generating a “stream”, or timeline, of consecutively created content. They may offer the user the option of creating folders, or renaming the files individually to provide a text based description of the content (which may then be used for an alphabetical organisation of the content). As all content in a normal stream or timeline has the same level of priority—and is only differentiated by date of origin—content is organised and presented only by what is most new, not what is best or most relevant to that user.

For a better understanding of the present invention and to show how the same may be carried into effect, reference will now be made by way of example to the accompanying drawings.

### BRIEF DESCRIPTION OF DRAWINGS

FIG. 1 illustrates hardware architecture of a smartphone used in implementation of a described embodiment;

FIG. 2 illustrates a network incorporating the smartphone of FIG. 1;

FIG. 3 illustrates a functional architecture of a content manager implemented by a server of the network illustrated in FIG. 2;

FIG. 4 illustrates a content item stored in a content store of the network illustrated in FIGS. 2 and 3;

FIG. 5 illustrates a graphical user interface displayed at the smartphone in implementation of the embodiment illustrated in the previous figures;

FIG. 6 illustrates a graphical user interface at the smartphone in implementation of the embodiment illustrated in the previous figures;

FIG. 7 illustrates a graphical user interface displayed at the smartphone in implementation of the embodiment illustrated in the previous figures.

FIG. 8 illustrates a graphical user interface for rating content items in a game; and

FIG. 9 illustrates a graphical user interface showing the results of a search query.

### DESCRIPTION OF EMBODIMENTS

The computer system and method described herein seek to address problems arising from the ever increasing amount of content available to a user on a computer device. Increasingly such content is stored remotely, for example in the cloud.

Large amounts of user generated content in the cloud being queried by—and delivered to—mobile devices will need to pass through a mobile data network. These are generally of poorer quality and speed than fixed line Internet connections, and the bandwidth consumption required for large amounts of user generated content can reduce the speed and reliability of the network and also of an individual user's device. The presentation of large amounts of unstructured user generated content requires significant use of device displays and processing power. Mobile devices generally have smaller displays, processors and batteries than desktop computers, and these limitations are all taxed by a large increase in the amount of user generated content owned by the user.

Additionally, users may wish to access the same content on multiple devices, each having different amounts of memory, processing power, screen size and connection speed. Traditional folder based or timeline based content organisation systems—where content items are all treated with the same priority level and only differentiated by date or name—don't adapt to these differing environments elegantly and require the device to determine which content is relevant to query, download, process and display.

An embodiment provides a computer apparatus operable to organise content items to which it has access, the apparatus being operable to gather content information describing content items to be organised, the content information comprising specification information associated with the content item and description information associated with the content item, the apparatus further comprising a user interface, the user interface being operable to cause generation of a display of representations of content items and to receive user input actions in relation to a content item or set of content items, and a prioritization manager, the prioritization manager being operable to determine, for each content item, a prioritization ranking, the prioritization manager determining said rankings on the basis of two or more criteria from said specification information, said description information, and user input actions in relation to a content item.

Another embodiment provides a method of organising content items, comprising gathering content information describing content items to be organised, the content information comprising specification information associated with the content item and description information associated with the content item, and offering to a user a user interface, the user interface being operable to cause generation of a display of representations of content items and to receive user input actions in relation to a content item, and determining, for each content item, a ranking, said rankings being determined on the basis of two or more criteria from said specification information, said description information, and user input actions in relation to a content item.

Another embodiment provides a method of organising content items, comprising a series of competitive games in which a small group of users—between 2 and 10, typically 5—are engaged, the competitive games comprising user generated content and specific information associated with the content item and a set of rules and a user interface, the user interface being operable to cause generation of a display of representations of content items and to receive user input actions in relation to content items, and determining, for each content item, a ranking, said rankings being determined on the basis of the user's input actions and status in the group, the status in the group being determined by the user's performance in previous games.

A computer program product may also be provided, which may be delivered in a storage medium or in the form of a signal (e.g. a download) to enable implementation of any aspect of the described embodiments. Part of any aspect of any embodiment may be provided by way of a web based implementation, where a website is exposed to a user, for a browser used by the user to present to the user a web page, allowing the user to make use of facilities of an embodiment.

Embodiments disclosed herein seek to provide benefit by creating a multi-layered system for all user-generated content. By this, the scarcest resources of computing devices—particularly mobile devices—of processing power, network connectivity, screen space and memory are not consumed with the handling of an abundance of user generated content but instead only manage the highest layers of prioritized user generated content. Multi-layer provides for ranking items of content using a plurality of influencing criteria. A formula for determining a prioritization ranking may depend on the specific implementation. Likewise, the exact criteria to be used in determining a prioritization ranking may vary from one implementation to another. Embodiments described herein use two or more criteria to identify which, of a plurality of content items, should be accorded a high, relative to other content items. This contrasts with other approaches where a single criterion, often binary in nature, is used to determine a user's “favourite” content items.

Embodiments disclosed herein also seek to provide benefit through the multi-layered system for all content by making the very best and most relevant content more visible in user interfaces. This results in less information needing to be transmitted between devices and servers, faster and more personalised responses to queries and less information needing to be stored and displayed on the device. Further, the prioritized content becomes easier to find and share.

Embodiments described herein also provide for user specific. By the storage of data on which is based, per user, content items may be assigned user specific rankings. This may be based on user preference and/or user behaviour in relation to the content items.

All content held in the system is assigned a prioritization points ranking per user, which can change over time. This prioritization is governed by three criteria: information known about the content, actions performed by the end user and that user's status in the group.

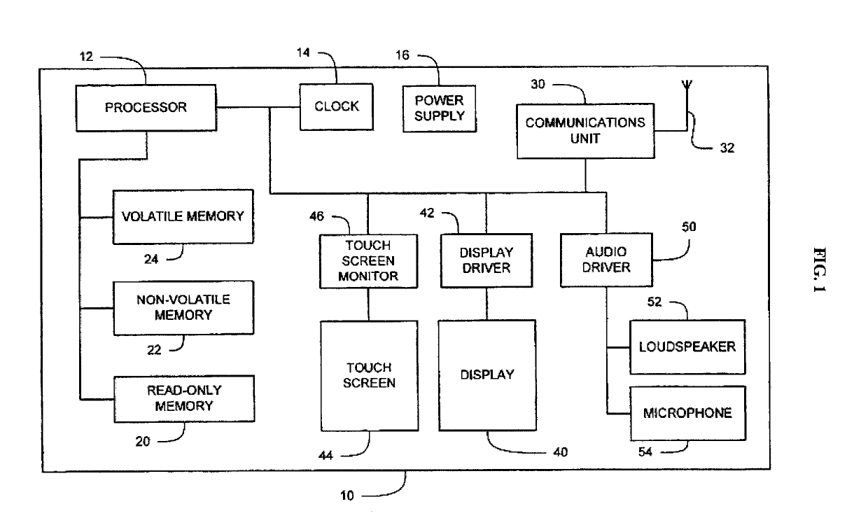

FIG. 1 illustrates hardware architecture of a mobile communications device, hereinafter referred to as a smartphone 10. The reader will appreciate that implementations of the embodiment do not rely on the provision of a smartphone, and this will be explained in more depth in due course.

The smartphone 10 comprises a processor 12, a clock 14 and a power supply 16.

The processor 12 receives a clock signal from the clock 14. For reasons of clarity, the connections from the power supply to other components of the smartphone are not illustrated, but it will be understood that power will be supplied as required.

The processor 12 has access to a read-only memory, ROM, 20, a non-volatile memory 22 and a volatile memory 24. The ROM 20 may be implemented by a solid-state device as is usual in such cases. The non-volatile memory 22 may, in the past, have been implemented by way of a magnetic storage device, such as a hard disk, but is more likely now to be implemented by solid state storage, such as flash memory. The volatile memory 24 is, by its nature, capable of being implemented by any memory device only operable in the presence of a power supply. It is not necessarily the case that a device needs to be provided with all three types of memory—access/write speed, power consumption and storage capacity will be factors in the design decision. One or more of the memory devices may be removable from the smartphone 10.

The memory devices 20, 22, 24 collectively provide facilities for the storage of data, for the storage of program instructions, and for the presentation of such instructions to the processor for execution. Further, the devices 20, 22, 24 provide the processor with interim data and program storage facilities so that the processor can execute program instructions as efficiently as possible.

A communication unit 30 operates with an antenna 32 to provide communication facilities to the smartphone 10. The particular communication facilities to be provided are not material to the present disclosure, but might include mobile telephony connections, local area radio network connections such as WiFi or Bluetooth, or other radio communications technology not yet fully formalised. The communication unit 30 may also offer electrical connection to another device, such as a computer, for instance by a USB connector.

By each of these potential connections, the communication unit 30 allows the smartphone 10 to gather and send data as required. It also offers the facility for computer program instructions to be received, such as software updates, new applications (so-called “apps”), plug-ins or the like, to change or enhance the operation of the smartphone 10. Such computer program instructions might be introduced on a signal, as described, or might be introduced as a product on a removable storage device (for instance, a flash memory card of suitable specification).

The smartphone 10 also comprises a display 40 operated via a display driver 42, and a corresponding touch screen 44 operated by a touch screen monitor 46. The display 40 is suitable for the display, to a user, of graphical display images to enable operation of the smartphone 10, including operation of the facility comprising the present embodiment. That facility will be described in further detail in due course. The touch screen 44 is sensitive to user touch, and converts user touches into input signals for capture by the touch screen monitor 46. Either at the touch screen monitor 46 or at the processor 12, these input signals are interpreted as user input commands.

An audio driver 50 provides control of generation of audio output at a loudspeaker 52 and captures and converts electrical signals generated at a microphone 54. Through this, audio output may be made by the smartphone 10, and audio input to the smartphone 10 may be achieved. Audio input may be for the purpose of onward transmission, such as on a telephone connection, or may be for the purpose of voice-activated control of the smartphone 10. It is conceivable that, with suitable configuration, the facilities to be described hereafter could be controlled by voice commands. The technology to support that is known in the field, and need not be described in depth here.

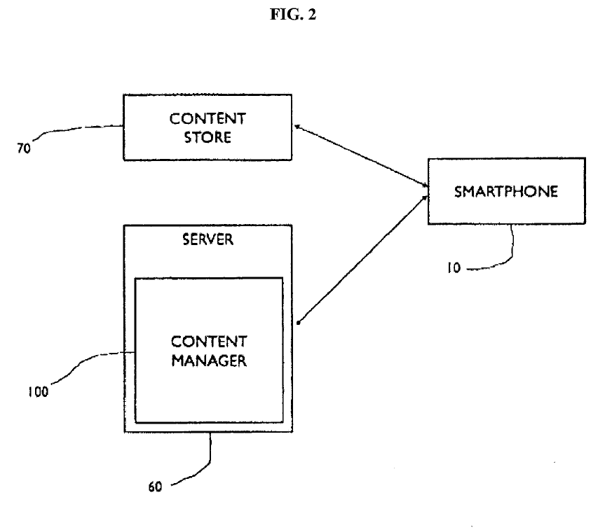

FIG. 2 illustrates a network in which the embodiment is implemented. The network comprises a server 60 in communication with the smartphone 10 previously described, and supporting a content manager 100. The server 60 is also in communication with a content store 70.

The reader will appreciate that the server 60 is of a commonplace construction for a general purpose computer. That is, it includes a processor and memory, enabling the execution of software. The content manager 100 may conveniently be implemented through the execution of suitable software.

The content store 70 is illustrated as being remote from the server 60. However, the reader will appreciate that the content store 70 may be integrated into the server 60, and that a plurality of content stores 70 may be provided in certain arrangements.

Connections between the smartphone 10 and the server 100 may be by any suitable means. Internet based connection, such as via a direct wireless link (e.g. by WiFi) or by indirect means (such as by mobile telephone RF signalling, e.g. 3G) will be understood to be contemplated within the scope of the present disclosure. Equally, the content store 70 may be hard-wired to the server, or may be entirely remote therefrom. Recent developments of remote storage facilities (such as those facilities known as cloud-based storage) are also to be considered within the scope of the present disclosure.

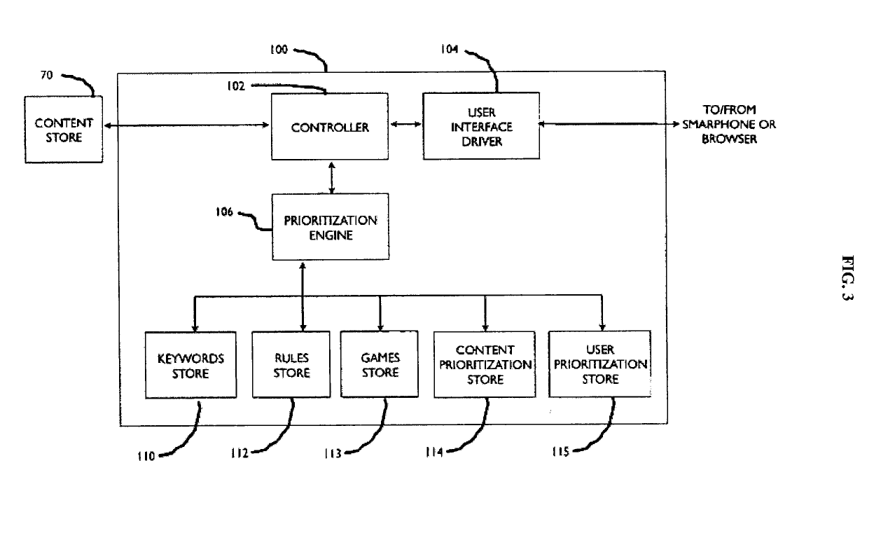

FIG. 3 illustrates a functional configuration of the network illustrated in FIG. 2. As will be understood from the following description, much of the processing involved in delivery of the embodiment is located at the server 60. The “client” implemented by the smartphone 10 is concerned with delivery of a graphical user interface to the user, and to collecting user input actions related to user behaviour and requirements. Functional configuration is achieved by the execution of software instructions by the processor of the server 60. It makes use of a software product, stored in memory, also potentially in conjunction with pre-existing software facilities inherent to the server 60, such as embedded in the operating system or lower layers of software therein.

Interaction at the smartphone 10 may be by means of a browser, or by means of a specifically designed piece of software, such as an app. This approach will be familiar to the reader.

The server 60 is thus configured to deliver a content manager 100 which accesses a content store 70 accessible by the smartphone such as at a wirelessly connected device (e.g. another computer) or further afield via the internet. The store at which the content is actually stored is immaterial to the operation of the content manager 100. The smartphone accesses the content store when the user selects content items, for example from those displayed to him, and retrieves the selected content items from the content store. The content server returns to the smartphone representations of the content items that include access components, such as a URL (uniform resource locator) which when selected (e.g. tapped or clicked) by a user, downloads the content item from the content store.

The content manager 100 comprises a controller 102 which oversees the operation of the content manager 100. The controller 102 is in communication with a user interface driver 104 which interacts with an application, known as a native application, or an “app” running at the smartphone 10 to deliver a graphical user interface at the display 40 thereof, and to receive user input commands generated by user touch gestures at the touch screen 44. The reader will appreciate that the provision of an app at the smartphone can be replaced by retrieval, by a browser running on the smartphone, of data defining a webpage, for presentation to a user.

The controller 102 interacts with a prioritization engine 106 which acts on content stored in the content store 70, and accesses and stores information in a keywords store 110, a rules store 112 and a prioritization rankings store 114. The manner in which the prioritization engine 106 does this will now be described.

As described more fully in the following, the prioritization manager is operable to determine a prioritization ranking of a content item in a number of different ways. For example, it can use at least one of the following criteria when determining a prioritization ranking. Some of these criteria operate in a context where the content item is displayed in a social media where the creator of the content item or other users of the social media can review the content item and post comments, etc. The prioritization ranking can be based on the content item or its title contain certain keywords, or whether user comments about the content item contain certain keywords and/or the amount of user comments for the content item.

Where the content item is editable or can be selected for inclusion in a photo book, the prioritization rankings can take these factors into account.

Where the content item is a photo, the prioritization ranking can take into account whether the photo contains smiling people and/or multiple people. Existing recognition algorithms can be utilised to determine whether these criteria are satisfied.

The prioritization rankings can take into account whether the content item has been marked as a favourite by one or more user, and/or the frequency with which one or more user has previously accessed the content item. Marking as a favourite can include marking in extent to which a user has “favourited” the item based on a sliding scale.

Again, in the context of social networks, a prioritization ranking can take into account whether the content item has been shared to another service. For example, a content item downloaded in an application can be shared to email or a social network service which differs from the original destination for the content item when it was loaded initially. The concept of “sharing” is known, and existing algorithms can be utilised for such sharing. The prioritization manager notes whether a content item has been shared using such sharing algorithms to form a basis for prioritization rankings.

The prioritization ranking can also take into account whether the content was captured in close time proximity to many other items. In this context, many can be determined by the number of other items in comparison with a threshold.

Where the content item has come from an external source, who added the content item, the source of the content item and/or the manner of import of the content item can form a basis for prioritization rankings.

Additionally or alternatively prioritization rankings can be based on the time and date recorded with the content item and the location where the location item was created.

The quality of the content item can also be utilised to form the basis of a prioritization ranking. In this context, the quality can be, for example, the resolution or clarity of an image such as a photograph.

The first driver for the prioritization of content is an algorithm which assesses many criteria about the content, ranging from the resolution of the image to the keywords which appear in comments about the image. All of this prioritization can happen without the user having to do any work and will happen in the background.

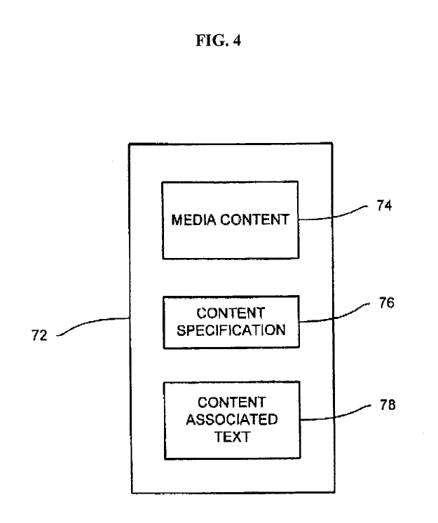

To do this, the prioritization engine 106 trawls the information held in the content store. A typical content record 72 in the content store is illustrated in FIG. 4. The content record 72 comprises a media content item 74, a content specification 76 and text 78 associated with the content. The content item 74 may be photographic, audio or video data encoded in any format, such as the formats agreed and recognised by international standard, or text. The content specification 76 may hold information as to the format of the content item 72, and also information such as the resolution of the content—if it is an image, the pixel resolution, for instance. It may also, in certain embodiments, store information concerning whether the content item has been edited by an application specific to the content manager 100, or by another proprietary media-editing program. The content associated text 78 may include a text description of the content item 72, including user entered and edited text, as appropriate. The user text entry and editing facilities may be offered through the graphical user interface of the present content manager 100, or may be offered through other facilities of the smartphone 10.

The prioritization engine 106 first reviews the content records held in the content store 70, to determine if content can be prioritized by reference to differences in the information held in the content specification record 76. In one embodiment, high resolution content is assigned a high prioritization ranking. The ranking for each record is stored in the prioritization rankings store 114.

Other criteria can be used to determine a prioritization ranking, on the basis of the properties of the content stored in the content store 70. For instance, the content store 70 may store, for each content item, the source of the content item, that is the device by which the content item was generated, and the manner in which the content item was imported to the content store 70. If the content item was generated by relatively high specification equipment (such as an SLR camera) this might influence the raising of the prioritization ranking score of the content item. Likewise, if the content was imported from a desktop computer, this might be viewed as imparting higher priority to the content item than if it were imported from a smartphone or other hand-held device.

Further, the circumstances of creation of the content item may be stored with the content item in the content store 70. This could include, by way of example, the time and date of creation of the content item and, if available, location information describing the location at which the content item was created. A prioritization ranking could reflect relative importance of significant dates (such as public or religious holidays, or birthdays of recognised users of the system) in determining relative importance of content. Further, if a content item was created in a location entirely different from many other content items in the content store 70, this could be indicative of the relative importance of the outlier content item.

Other matters inherent to a content item can include whether the content item has an aspect ratio which is non-standard. Even if information is not available as to whether a content item has been edited, and by what means, a non-standard aspect ratio can be indicative of this. From this, it can be inferred that the content is of importance to the creator or editor of the content item, and that a higher prioritization ranking may be applied to reflect this. Similarly, if editing records are available, indicating that action has been taken to improve a content item, such as to increase contrast, to remove red-eye effects or to modify the content of a photograph in some other way, this also implies a perceived importance of the content item to a user. This also can be used to prioritize content through the prioritization ranking score.

Content items can be compared with each other. This allows detection as to whether content items are very similar. This can be done on the basis of pixel comparison or time of creation, or both. A prioritization ranking score can be assigned with an aim to prioritize only one content item of a set of similar content items, if such a scenario is detected.

The prioritization engine 106 also reviews data held in the content associated text data item 78 for each content item 72. The text data is scanned for keywords. These keywords may be pre-stored in the keywords store 110, or may be determined on the basis of frequency of words arising in the review. New keywords identified in the review are then stored in the keywords store 110, for future reviews of further content records 72. The review may include comparison of words with a view to similarity, as well as to identity, as user entered data sometimes includes inconsistencies of spelling, grammar or typography (e.g. capitalization) which may need to be accommodated in the review.

The prioritization engine 106 is operable to assign the prioritization rankings on the basis of the identification of keywords. The exact rules for assignment of prioritization are rules based. Rules are stored in the rules store 112, to enable this prioritization.

For example, the prioritization engine 106 can assign a higher priority to a content item with associated comments, descriptive text, or title, containing one or more identified high-priority keywords. If the content item is a text item, then the text item itself can be reviewed, or metadata associated with the text item may be sufficient for this. It may be sufficient, to determine priority based on which of the content items has been commented upon (and how many times), and which have not.

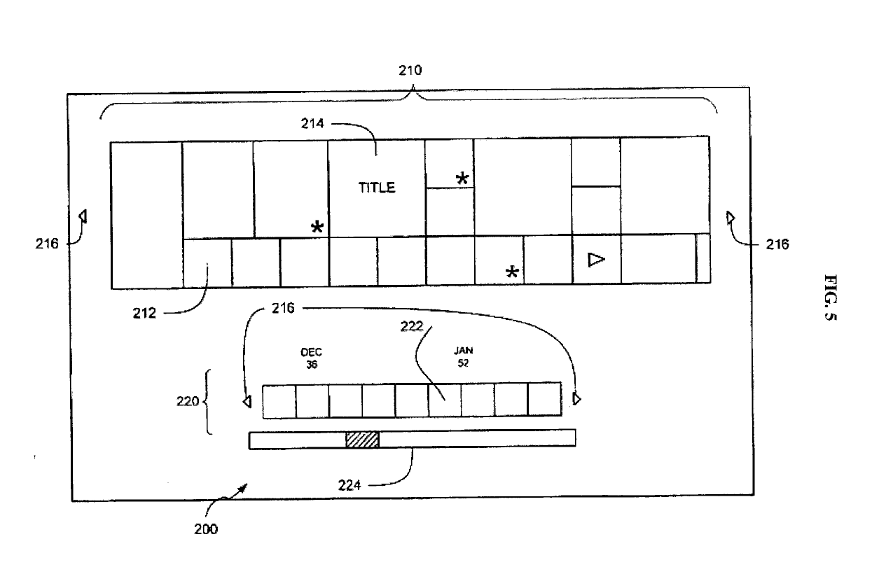

Further, the prioritization engine 106 is operable to assign the prioritization rankings on the basis of user input actions. User input commands may be received by the user interface driver, relating to the manipulation of content items on screen by the user. FIG. 5 illustrates a graphical user interface 200, inviting user input action.

The interface 200 is shown with two main regions. An upper region 210 comprises a plurality of cells, each cell containing a representation of a media content item. Most of those illustrated are photographic items 212, but one, indicated 212′ is of a video item. As for other systems currently in place, this might be represented by a still image from the video content, or by a blank cell (perhaps in a solid colour) and indicated by an arrow. As noted above, text stories and audio recordings can be implemented as content items as well.

The items are represented in different shapes and sizes. The size and shapes of the items are dictated by the prioritization system, as determined by the prioritization engine 106 of the content manager 100, but can be modified by the user through touch commands. This could be by dual touch dragging or by using a menuing system supported by the operating system of the smartphone platform. A title cell 214 is also shown. The sequence of cells runs from left to right—the total number of cells selected by the user may be larger than can be capably displayed on screen, so a scrolling representation is provided, as indicated by arrows 216, through which the user can review through the “roll” of selected cells 212, 214.

Additionally, the viewing of content, by a user, may also be monitored by the content manager 100. The content manager keeps a record, in a computer system, of the occasions on which a content item, or indeed a data item in general, has been accessed by an application. Thus, when a content item is accessed by a viewer application, then the access of that item can be considered an indication of interest in that item by the user. The frequency of viewing of an item is indicative of the interest therein. The prioritization score for an item may be a function of the frequency of viewing of the item. The level of influence of number of views on the final prioritization score will depend on the implementation.

The selected cells 212, 214 of the upper region are selected from the total library of available content, as indicated by the roll of cells 222 in a lower region 220 of the graphical user interface. The library of content in the roll of cells 222 is presented in timeline form. Timeline indicators (indicative of the date of creation, upload or otherwise) of particular content items, and the number of content items associated with a particular time period (“Dec 36” indicating that there are 36 content items associated with December) are shown adjacent the roll of cells 222. A scrolling bar 224 enables navigation through the content represented in the roll of cells 222.

The selection takes place in two ways. First, the controller 102 draws from the prioritization rankings store a list of content items which have the highest prioritization rankings. These are firstly presented to the user in the upper region 210. Then, through the user interface, the user can move content from the lower region 220 to the upper region 210, and change its size and position—by touch screen manipulation—to indicate which content is more important to that user. As well as the user interface responding to these user input actions by changing the display, the prioritization engine 106 dynamically adjusts the relative ranking of the content that is moved. So, a content item that is promoted to the upper region 210 correspondingly has its prioritization ranking score promoted—equally, a user input action indicative of increasing the size of display of a content item indicates a desire that the item should be accorded a higher priority and this is also reflected in prioritization scores.

Further, as indicated by asterisks in FIG. 4, it is possible for items to have comments attached thereto. These comments may be from the native system, such as stored in the content associated text 78, or may be input by users of the content manager 100. The user interface may therefore offer a facility (not shown) for users to post comments against content items. The prioritization engine 106 can modify prioritization rankings for such content items in several ways. For instance, at a basic level, the prioritization engine 106 can apply a higher prioritization ranking to content items with comments, than those without. It can rank content items in order of the number of comments.

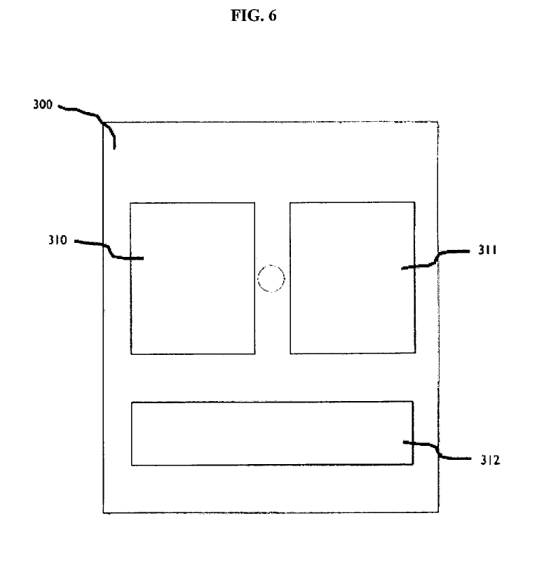

Further, the Prioritization Engine 106 is operable to assign the prioritization rankings on the basis of user input actions from games. User input commands may be received by the user interface driver, relating to the selection of content in a game or the adding of metadata to a piece of content. FIG. 6 illustrates a graphical user interface 300, inviting user input action.

The interface 300 is shown with three main regions. A region 310 comprises one piece of user generated content from the Content Store 70, while a region 311 is another piece of content from Content Store 70, as determined by the Prioritization Engine 106. content 310 and content 311 may be photos, videos, audio or text and will usually have the same prioritization ranking, so the game can determine which should be higher. There may also be a region 312 for the display of metadata entered by other users and relating to region 310 and/or region 311.

Which content is displayed in the game and their position are dictated by the prioritization system, as determined by the Prioritization Engine 106 of the Content Manager 100. One game may involve the user indicating their preferred piece of content between the two, which is communicated back to the Prioritization Engine 106 and increases that content's ranking. The user's preference may have more or less weighting on the change in the Content Prioritization Store 114, depending on that user's ranking in the User Prioritization Rankings Store 115. Also, as the user completes a game, their own ranking as a user may increase in the User Prioritization Rankings Store 115, depending on what is specified in the Rules Store 112.

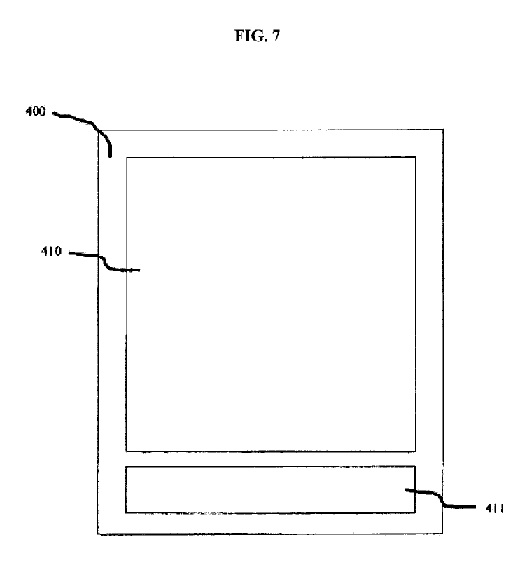

In FIG. 7 a user interface is comprised of two main regions. In region 411 the user is invited to enter some metadata related to the content in region 410, like an amusing caption or a keyword tag, which will become part of the metadata for the content 410 and is transmitted back to the Content Store 70. As this metadata is entered, it will be added to the Content Associated Text 78 for the content record 72, and the user's action will be communicated to the User Prioritization Store 115 where their ranking may increase. Finally, this metadata can be used in the game in FIG. 6, where other users can vote on their preferred content and metadata.

The rankings In the Content Prioritization Store 114 may be determined as a calculation, combining many or all of the above-described criteria, according to rules, influenced to some extent (but by no means wholly) by the number and content of comments. Further, as noted above, the comments may be analysed by the prioritization engine against keywords held in the keyword score. The keyword store may include words which have generally positive meanings, such as “beautiful” or “great”—existence of such words might positively influence the prioritization of a particular content item.

To summarise, therefore, the prioritization ranking can be affected by user input actions. The prioritization engine 106 is responsive to various issues, to a degree dependent on the implementation, in determining prioritization ranking scores. Further, as user behaviour is entirely personal to that user (in that different users will prefer different content items, to varying degrees), data supporting calculation of prioritization ranking scores can be associated with particular users, by storing user information in a user register and associating prioritization ranking scores with particular users. Likewise, users' actions can have different weighting, depending on their ranking in the User Prioritization Store 115.

Particular user behaviours which can impact on the prioritization ranking scores will now be set out, as a non-exclusive list.

First, prioritization may be affected by whether the user has moved the content item into the featured area represented by the upper region 210 in FIG. 5. Also, if the user re-sizes the content item, making it bigger or smaller, this can indicate the perceived priority of that item to the user, and this can influence the user-specific prioritization score for that content item.

There can be a facility for a user to mark a content item as a favourite. This can be a user-specific indication, but it can also affect the overall prioritization score for that content item, for all users, if several users so indicate that content item as a favourite.

There can be a facility for a user to tag representations of objects, or people, in photographs. This can be used to indicate a higher priority of a particular content item relative to another. This may be particularly the case if a user is known to have a relationship, such as a family relationship, with subjects in a particular photograph.

There can be a facility for users to play interactive games with the content in FIG. 6, gaining points by indicating preferences, as in the left region 310 or the right region 311. They may also entering relevant metadata in region 411 of FIG. 7. These indicated preferences and additional metadata can then be used to further prioritize content in the Content Prioritization Store 114.

### Game Examples

The goal for the games is to prioritize content (to optimise for processing, storage and data transmission restrictions on devices). The following are three examples of interactive, competitive games that achieve this function. While it is expected that multiple users (players) will be engaged in a game, a game may also be played with a single user (player).

Creativity: Users will create something beautiful with the content available—a collage or slideshow—and other members of the family will vote on their favourite in a time period. The winner gets points (and a by-product is that the content selected in the collages or slideshows gets more priority).

Preference: Users will be periodically be presented with NB options—in a series—to quickly tap on which they prefer between two photos. Every user that completes this rating within a series will get more points (and a by-product is that content is prioritized).

Activity: Users will get points for every time they are active in the app—posting, commenting, viewing, playing, anything. At the end of a month, the person(s) with more points will win and their votes will count more when prioritising content.

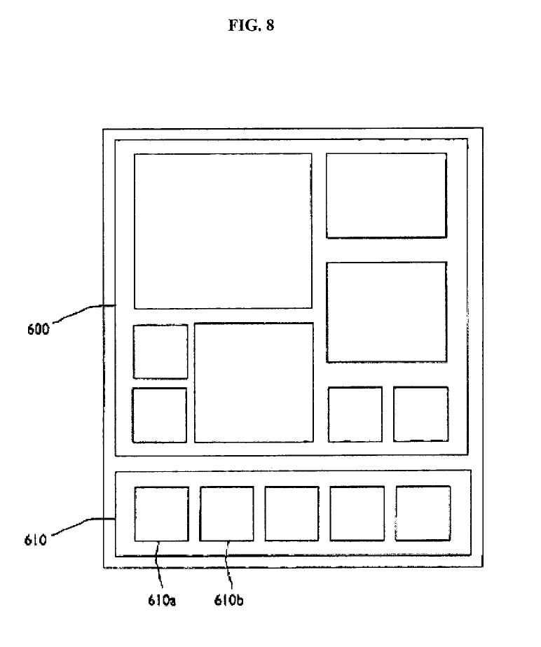

FIG. 8 illustrates a display where reference numeral 600 is a collage a user creates by dragging in content from a content selection 610. The content selection is a display of individual content items 610 a, 610 b etc. The collages are voted on by other users. The collage with the most votes ‘wins’. The creator of that collage gains prioritisation points, and the content items may also achieve higher rankings.

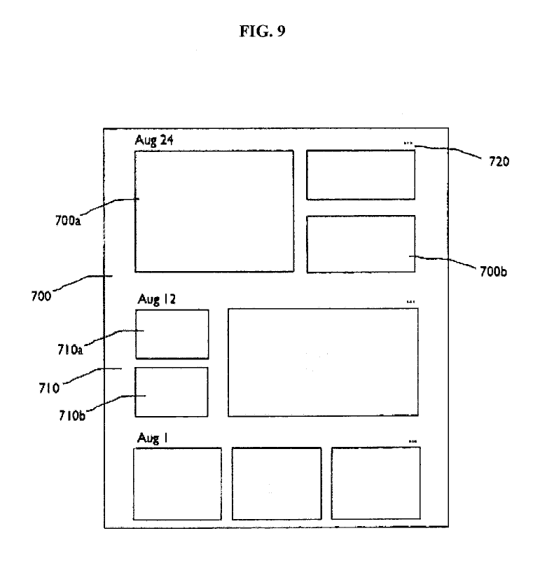

FIG. 9 shows a return of a request for content for the month of August. Each date block (700 and 710) displays a subset of content items (700a, 700b; 710a, 710b) for those days. The remaining items are accessible (with a link at 720), but the user is shown fewer, more relevant responses to their query. In the case where August had a large number of content items matching the date criteria, the present disclosure allows only relevant items to be returned, without any action needed by a user—for example additional search terms etc. the prioritisation manager has returned the highest ranking items only.

The controller 102 further offers to the user, through the user interface, the facility to make a book of selected content from the total available content. This book can be created from content prioritized by the prioritization engine. The controller 102 thus automatically selects most favoured content, for presentation to the user prior to the book being finally generated. Thus, the starting point for a user is significantly more convenient than starting to develop a book from the total available content—the most favoured content is known to the content manager 100 already. The book may be printed onto physical medium, or stored on a storage medium for later viewing. The book may be placed on a shared storage facility to allow viewing by third parties, such as through authorisation by the user generating the book.

The reader will appreciate that, while the present embodiment has been described with reference to a smartphone, other platforms may be suitable to support implementation.

For instance, tablets, which often operate on similar operating systems to modern smartphones, can readily be used. Equally, a desktop application, such as browser driven, will be suitable to allow implementation on a general purpose computer, such as a computer running a Windows operating system delivered by Microsoft Corporation of Redmond, Wash., USA, or a computer delivered by Apple Inc. of Cupertino, Calif., USA.

Previous approaches treat all content equally, meaning that the user has to take substantial steps to create a prioritization of content items when assembling an order of interest. Furthermore, each device has only scarce memory, bandwidth, screen and power resources to store, display and manage large amounts of user generated content. There is no fundamental priority within a group of content items. In contrast, the above described embodiment provides a facility whereby the prioritization can at least in part be carried out automatically, enabling a user merely to modify from a starting point, or accepting the computer's proposal as a suitable selection of content.

This also means that, whereas in previous approaches, the introduction of more content increases the risk that favoured content will be increasingly difficult to find, the present embodiment enables the content manager to review new content and assess its interest to the user using past experience, information associated with the content, and rules defined by the user. In that way, content can be more easily managed, presented to a user, and selected for further processing.

The embodiments above have the advantage of reducing the amount of content transmitted in response to user queries or searches. Cloud storage systems generally organise content by name, folder, date or tag. As clients have restricted amounts of storage, they will make queries to the server(s) for content. For example, a client may request folders A, B and C or content from dates Y to Z. In existing systems, the response to that query returns all the data that matches. In the present disclosure, the server responds to queries on date ranges by returning initially only the highest priority items for that date period. So the data transmitted can be markedly less (while providing the user with an experience which is actually better in terms of relevant content).

Queries can come from a client device at several points: when the user actively searches for something, when the application refreshes itself after a period of inactivity and when a contact of the user performs an action which triggers a notification and subsequent update in the user's client.

For example if a first user posts a comment on some content associated with a second user—for example on a social network platform—the second user receives a notification and the client at the second user device will also update itself with new content. In accordance with the present disclosure, that update has an optimised data transmission by returning relevant higher ranked content only.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1-24. (canceled)

25. A computer apparatus operable to organise content items to which it has access, the apparatus comprising:
receiving means operable to gather content information describing content items to be organised, the content information comprising specification information associated with the content item and description information associated with the content item;
a user interface presentation means operable to cause generation of a display of representations of content items and to receive user input actions in relation to content items; and
a prioritization manager, the prioritization manager being operable to determine, for each content item, a prioritization ranking, the prioritization manager determining said rankings on the basis of two or more criteria from said specification information, said description information, and user input actions in relation to a content item.

26. The apparatus in accordance with claim 25, wherein the user interface is operable to cause generation of said display of representations on the basis of said prioritization rankings.

27. The apparatus in accordance with claim 25, wherein the user interface is operable to offer a facility for a user to input information for association with a content item, and wherein the apparatus is operable to store the input information in association with the content item.

28. The apparatus in accordance with claim 27, wherein the input information is text information and the description information is text information and comprising a keyword store storing text information describing keywords, and wherein the prioritization manager is operable to process text information associated with a content item and to determine the prioritization ranking for that content item based on the presence or otherwise in the text information of one or more of said stored keywords.

29. The apparatus in accordance with claim 28, wherein the presence of a keyword is determined based on a similarity score between text information of a content item and text information describing a keyword in the keyword store.

30. The apparatus in accordance with claim 25, wherein the prioritization manager is operable to determine a prioritization ranking on the basis of information describing graphical resolution of a content item, contained in said specification information.

31. The apparatus in accordance with claim 25, wherein the user interface defines a first region and a second region in said display, the first region being associated with a high priority and the second region being associated with a lower priority, the apparatus being operable to place, in the first region, representations of content items determined to have a relatively high prioritization ranking.

32. The apparatus in accordance with claim 31, wherein the prioritization manager is responsive to a user input action to move a representation of a content item into the first region by modifying the prioritization ranking of said item to indicate a higher priority for the content item.

33. The apparatus in accordance with claim 25, wherein the prioritization manager is operable to determine a prioritization ranking of a content item using at least one of the following contained in the specification information:
whether user comments about a content item contain certain keywords;
the amount of user comments for the content item;
the format of the content item;
the source of the content item;
the manner of import of the content item when previously accessed;
time and date recorded with content item;
location where the content item was created;
quality of the content item;
whether the content item was edited;
whether the content item has been selected for inclusion in a photo book;
whether the content item is a photo containing smiling people;
whether the content item is a photo containing multiple people;
whether the content item marked as favourite by one or more user;
the frequency with which one or more user previously accessed the content item;
whether the content item or a title associated with content items contains certain keywords;
the amount of times one of more user has stopped a scrolling screen to view the content item;
who added the content item to a content store;
whether the content item has been shared;
whether the content item was captured in close time proximity to a number of other content items exceeding a threshold; and
the extent to which a user has indicated favouritism for the content item, based on a scale of favouritism.

34. The apparatus in accordance with claim 25, wherein the prioritization manager is responsive to a user engaging in an interactive game, wherein the interactive game generates a game score for the user engaged in the game.

35. The apparatus according to claim 34, wherein the prioritization manager allocates different priority rankings to each of the users engaged in the interactive game based on their game score, the prioritization manager utilising the priority rankings allocated to different users to determine rankings for content items associated with the different users, wherein the users' actions have different weightings depending on their priority rankings, the weightings used to adjust priority rankings of a content item associated with that user.

36. The apparatus according to claim 34, wherein the prioritization manager is operable to utilise the game score to determine prioritization rankings for content items.

37. The apparatus according to claim 34, wherein a user input action in an interactive game is at least one of:
inputting metadata associated with a content item; and
selecting a content item from one region over another.

38. The apparatus in accordance with claim 25, wherein the prioritization manager is operable to store a user input action in relation to a content item in association with user identification information, and to determine said prioritization rankings for a particular user with regard to user input actions relating to that user.

39. A computer program product comprising computer executable instructions which, when executed by a general purpose computer, cause that computer to become configured as apparatus in accordance with claim 25.

40. A computer system comprising:
the computer apparatus according to claim 25;
a computer device in communication with the computer apparatus and operable to display the representations of content items responsive to the user interface presentation means and to transmit user input actions responsive to user interaction with the display on the computer device; and
a content store accessible by the computer device, wherein the computer device is operable to access content items from the content store based on representations of the content items on the display.

41. The computer system according to claim 40, wherein the representations comprise access elements selectable by a user to access the content item(s) from the content store.

42. A method of organising content items, comprising gathering content information describing content items to be organized, the content information comprising specification information associated with the content item and description information associated with the content item, and offering to a user a user interface, the user interface being operable to cause generation of a display of representations of content items and to receive user input actions in relation to a content item, and determining, for each content item, a prioritization ranking, said rankings being determined on the basis of two or more criteria from said specification information, said description information, and user input actions in relation to a content item.

43. A computer implemented method of organising content items comprising delivering at least one interactive game to a group of users, wherein delivering the interactive game comprises delivering a user interface to each user, the user interface being operable to cause generation of a display of representation of content items and to receive user input actions in relation to the content items, wherein the content items have been generated by users; and
determining for each content item a prioritization ranking, the ranking being determined on the basis of input actions of a user and the status of that user in the group.

44. The method according to claim 43, wherein the status in the group is determined by the users' performance in previous games, and wherein the method of organising content items comprises recording user status based on the performance in games.
